(19) United States
(12) Patent Application Publication
(10) Pub. No.: US 2011/0239847 A1
(43) Pub. Date: Oct. 6, 2011

(54) ELECTRONIC DRUMSTICKS SYSTEM

(76) Inventors: Craig Small, Framingham, MA (US); Mark Izen, Chestnut Hill, MA (US)

(21) Appl. No.: 13/020,338

(22) Filed: Feb. 3, 2011

Related U.S. Application Data
(60) Provisional application No. 61/301,369, filed on Feb. 4, 2010.

(51) Int. Cl. G10D 13/02; G10H 3/00

(52) U.S. Cl. 84/723; 84/422.4

(57) ABSTRACT

A portable system for drumming is provided that simulates a full drum kit. In one implementation, a system is provided that can digitally simulate a full drum kit without the need for actual drums. The system can include electronic drumsticks that can transmit digitally sampled drum sounds (e.g., snare, kick drum, high-tom, low-tom, cymbal) wirelessly to a receiver. The receiver can connect to one or more outputs, such as headphones or a stereo system. The receiver may also be configured to mix audio signals produced by the drumsticks with other audio inputs such as an MP3 player to permit a user to drum along with prerecorded music.

### RELATED APPLICATIONS

This application claims priority under 35 U.S.C. §119(e) to U.S. Provisional Patent Application Ser. No. 61/301,369, entitled “ELECTRONIC DRUMSTICKS SYSTEM,” filed on Feb. 4, 2010, of which application is incorporated herein by its entirety.

### FIELD OF THE INVENTION

The invention relates generally to musical instruments, and more specifically to systems associated with playing drums.

### BACKGROUND

A drum kit is a collection of drums, cymbals, and often other percussion instruments (e.g., blocks, chimes, etc.) arranged for play by a person (e.g., a drummer). Drums are generally struck to produce sounds by a variety of instruments held in the hand, such as drumsticks. A full drum kit may include many elements, including, but not limited to, a bass drum (played by a foot operated pedal), floor tom, snare drum, tom-toms, and a variety of cymbals, such as a hi-hat cymbal, ride cymbal and crash cymbal.

### SUMMARY

It is appreciated that drum kits are inconvenient, as full drum kits generally take up a large amount of room and are not portable without undue effort. According to one aspect of the present invention, a portable system for drumming is provided that simulates a full drum kit. Generally, one aspect of the present invention provides a system that can digitally simulate a full drum kit without the need for actual drums. In one embodiment, the system can include electronic drumsticks that can transmit digitally sampled drum sounds (e.g., snare, kick drum, high-tom, low-tom, cymbal) wirelessly to a receiver. The receiver may be housed within a portable unit so that the user may easily move the system to different locations.

Users can utilize the electronic drumsticks to activate a snare, cymbal, high-tom, low-tom and kick drum sound by striking a surface with one or both of the electronic drumsticks. The strike signal can be wirelessly transmitted from the stick to the receiver and then made audible through an output of the user's choice (e.g., earbuds, headphones, amplifier, stereo system, public address (PA) system, or other amplification and/or listening system). For example, a user can plug headphones into the receiver to hear himself/herself play, or the user may plug the receiver into an amp, PA or stereo system so that multiple people are permitted to hear.

Auxiliary inputs may also be included so that users can play along with music produced by personal music systems such as an iPod or an MP3 player, or other instruments or devices. For example, a user can plug his/her personal music system (e.g., an iPod) into one of the auxiliary inputs and play along with pre-recorded songs stored on the personal music system. In addition, the receiver can include one or more prerecorded tracks that can be played along with the drum sounds produced by the user. For instance, the receiver may include several built-in hi-hat beat tracks (e.g., in eighth and sixteenth notes) that may be mixed with the user inputs produced by the drumsticks. Further, the tempo of the tracks may be adjusted (e.g., tempo up and down) by way of a control provided by the receiver.

The receiver may be a separate element of the drumsticks system, or may be part of at least one of the wireless drumsticks. The receiver may include any number of inputs for the purpose of mixing input audio signals with received signals produced by the drumsticks. The receiver itself may include any number of prerecorded tracks that could be mixed with the signals produced by the drumsticks, and any number of input signals. The receiver may also include one or more audio signal outputs that can be connected to a listening device (e.g., earbuds), an amplifier, stereo or other system capable of receiving an audio input.

According to one aspect of the present invention, an electronic music system is provided comprising at least one drumstick including a detector that detects play of the at least one drumstick, a transmitter that is capable of transmitting information indicating the play of the at least one drumstick, a receiver that receives information indicating the play of the at least one drumstick, the receiver having an audio input capable of accepting an input audio signal, and wherein the receiver is configured to combine the input audio signal with an audio signal corresponding to the information indicating the play of the at least one drumstick, and wherein the receiver provides, as an output, an output audio signal representing the combined input audio signal and audio signal indicating the play of the at least one drumstick.

According to one embodiment of the present invention, the transmitter is configured to transmit the information to the receiver using a wireless communication protocol. According to another embodiment, the receiver includes at least one preprogrammed track stored in a memory device of the receiver. According to another embodiment, the receiver is adapted to combine the preprogrammed track with the combined input audio signal and audio signal indicating the play of the at least one drumstick. According to another embodiment, the receiver includes a control that permits a user to select the at least one preprogrammed track.

According to another embodiment, the at least one drumstick and the receiver are part of a portable system. According to another embodiment, the receiver is housed within another drumstick. According to another embodiment, the receiver includes a control adapted to adjust a tempo of the at least one preprogrammed track.

According to another embodiment, the receiver includes a control to adjust an output level of the output audio signal. According to another embodiment, the audio input is capable of being coupled to an output of a personal music player. According to another embodiment, the at least one drumstick comprises an infrared transmitter and is adapted to transmit the information indicating the play of the at least one drumstick to the receiver via the infrared transmitter.

According to another aspect of the present invention, a method is provided for processing audio signals, the method comprising acts of electronically detecting play of at least one drumstick, transmitting information indicating the play of the at least one drumstick, receiving, by a receiver, information indicating the play of the at least one drumstick, the receiver having an audio input, receiving, by the receiver, an input audio signal, combining, by the receiver, the input audio signal with an audio signal corresponding to the information indicating the play of the at least one drumstick, and providing, as an output, an output audio signal representing the combined input audio signal and audio signal indicating the play of the at least one drumstick.

According to one embodiment of the present invention, the method further comprises an act of transmitting the information to the receiver using a wireless communication protocol. According to another embodiment, the method further comprises an act of storing, within a memory device of the receiver, at least one preprogrammed track. According to another embodiment, the method further comprises an act of combining the preprogrammed track with the combined input audio signal and audio signal indicating the play of the at least one drumstick.

According to another embodiment, the method further comprises an act of providing a control that permits a user to select the at least one preprogrammed track. According to another embodiment, the at least one drumstick and the receiver are part of a portable system. According to another embodiment, the receiver is housed within another drumstick. According to another embodiment, the method further comprises an act of providing a control adapted to adjust a tempo of the at least one preprogrammed track.

According to another embodiment, the method further comprises an act of providing a control to adjust an output level of the output audio signal. According to another embodiment, the audio input is capable of being coupled to an output of a personal music player. According to another embodiment, the method further comprises an act of transmitting, by an infrared transmitter of the at least one drumstick, the information indicating the play of the at least one drumstick to the receiver.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing an electronic music system according to one embodiment of the present invention;

FIG. 2 is a block diagram of a receiver according to one embodiment of the present invention;

FIG. 3 is a diagram showing an electronic music system according to another embodiment of the present invention;

FIG. 4 is a diagram showing a user playing an electronic music system according to one embodiment of the present invention;

FIG. 5 is a flow chart showing a process for processing audio information according to one embodiment of the present invention;

FIG. 6 is a circuit diagram showing transmitter circuitry according to one embodiment of the present invention; and

FIG. 7 is a circuit diagram showing receiver circuitry according to one embodiment of the present invention.

### DETAILED DESCRIPTION

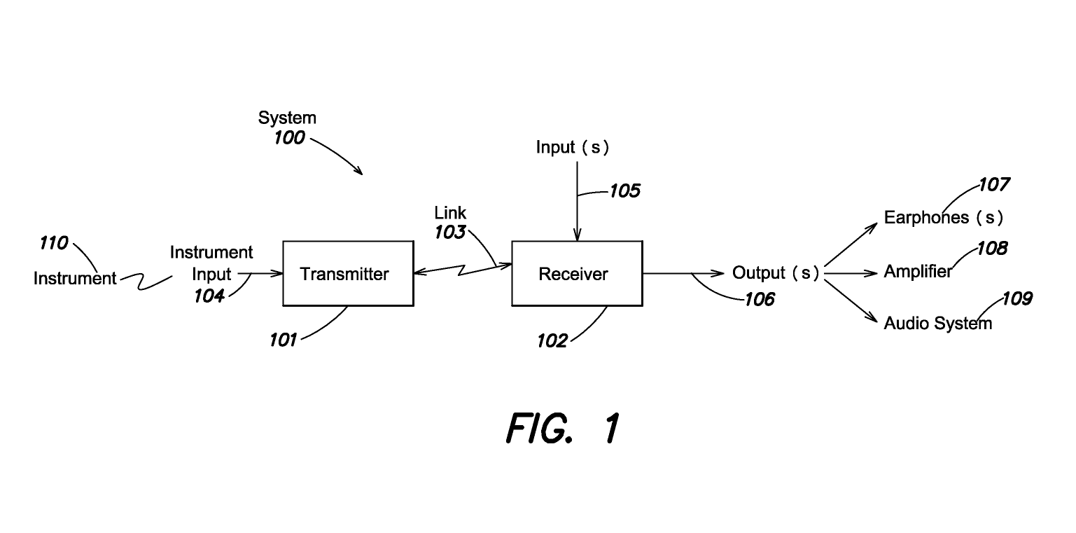

FIG. 1 shows one example electronic system 100 according to one embodiment of the present invention. In particular, there may be one or more components of a portable music system that permit a user to simulate an instrument, such as a drum kit. However, it should be appreciated that other instrument types may be used. In one embodiment, the electronic system produces audio signals that simulate a full drum kit, without the need for actual drums. To this end, the system may include an instrument apparatus 110, such as drumsticks that produce an instrument input 104.

In one embodiment, input 104 may include information that indicates what type(s) of drum sounds are being produced by instrument 110. For instance, the instrument may produce information indicative of a snare, cymbal, high-tom, low-tom and kick drum sound, depending how the drumsticks are moved, and what controls, or combinations of controls and movement are performed by the user. Such sounds may be encoded and stored in a memory associated with system 100 (e.g., in a memory of a chip, controller, or other system).

When a particular sound is activated, the audio signal or other information associated with the sound may be transmitted by transmitter 101 to a receiver 102 via link 103. Link 103 may include, for instance, a wireless communication link using one or more wireless protocols (e.g., WiFi, Bluetooth, infrared or other communication protocol).

Receiver 102 receives the information and provide one or more audio output(s) 106. On these outputs, receiver 102 may transmit audio signals representing the received information. Further, receiver 102 may include one or more audio input(s) 105, such as an MP3, iPod, stereo or other audio input. Input audio information may be mixed with the audio information produced by playing the drumsticks, and this mixed audio may be provided as an output audio signal at output 106.

Output(s) 106 may be coupled to one or more components, such as earphones 107 or similar component (e.g., earbuds, headphones, etc.), one or more amplifiers 108 capable of playing the audio signal through speakers, or any other audio system 109 capable of receiving and processing audio signals.

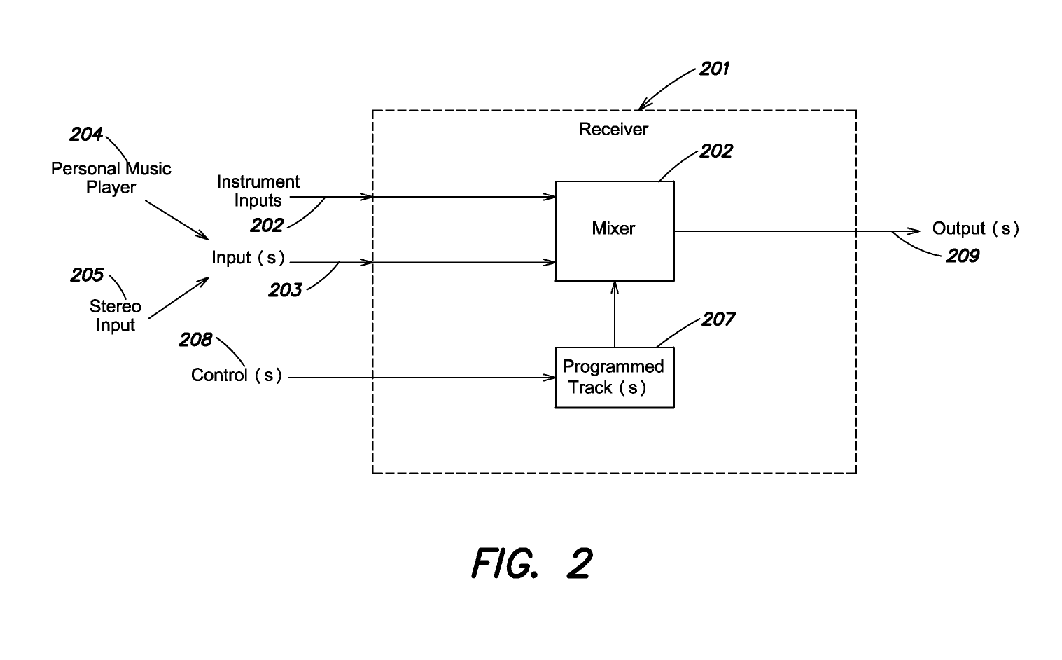

FIG. 2 shows one embodiment of a receiver 201 according to one embodiment of the present invention. For instance, receiver 201 may be one example of an implementation of receiver 102 discussed above. Receiver 201 may include one or more instrument inputs 202 and input(s) 203 that may be mixed by a mixer 206 to form one or more output audio signals that can be placed on one or more output(s) 209. In one example as discussed above, one type of instrument input may include audio signals representing drum sounds.

Further, one or more inputs 203 may include a personal music player 204 input (e.g., an MP3 player, iPod device, or other player) and/or stereo input 205. These inputs 203 may be mixed with instrument input 202 to form an output audio signal. Notably, the receiver may permit the user to play the instrument along with prerecorded music received through inputs 203.

Receiver 201 may also include a number of controls 208 that permit one or more preprogrammed track(s) 207 to be mixed with the input audio signals 202, 203. For instance, receiver 201 may include one or more preprogrammed drum tracks that are stored in a memory associated with receiver 201 and are selectively activated by the user using controls 208. Controls 208 may also include controls that adjust the track for tempo, volume, or other parameter relating to the track. In one embodiment, users may also be permitted to record tracks that they have played and store these tracks as prerecorded tracks that the user can play along with at a later time.

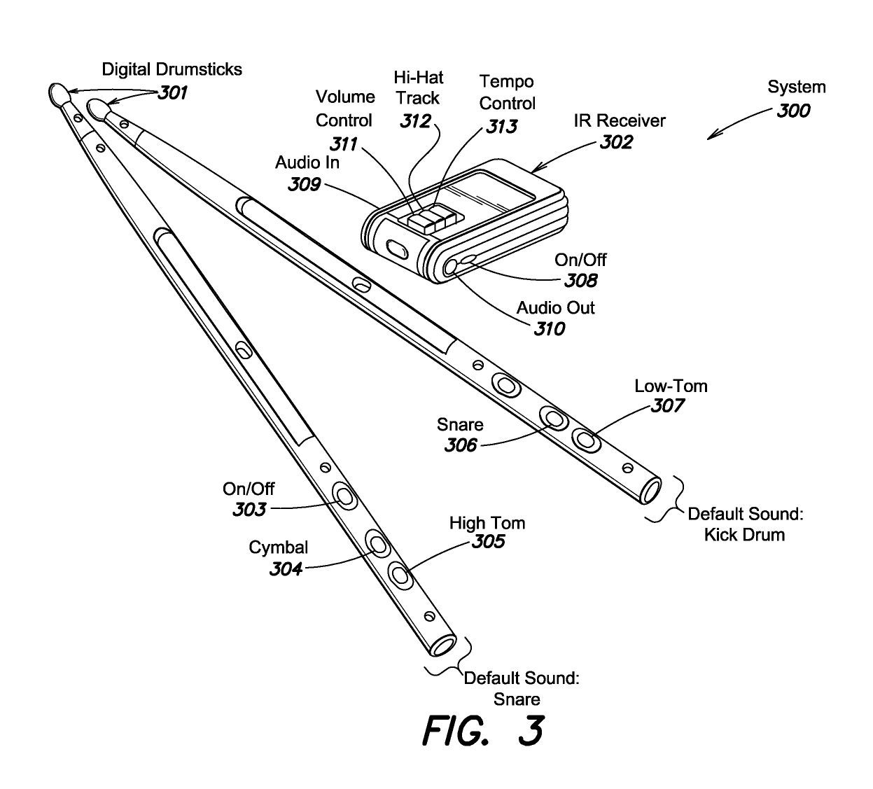

FIG. 3 shows one embodiment of an electronic music system according to another embodiment of the present invention. In particular, music system 300 may include a pair of digital drumsticks 301 which are configured to produce drum sounds based on user input. Signals indicating these drum sounds may be communicated to a receiver 302, and played to a variety of outputs.

Drumsticks 301 may include one or more controls that activate/deactivate the drumsticks, and change the sounds generated by them. For instance, digital drumsticks 301 may include an on/off switch 303, which when pressed may activate both the drumsticks 301 and the receiver 302. Drumsticks 301 may also include a number of controls such as cymbal control 304, high tom control 305, low tom control 307 and snare control 306, that, when selected by a user, change the drum sound of a corresponding drumstick to the selected sound. Drumsticks 301 may also include default sounds if no controls are activated, such as a snare or kick drum sound.

In another embodiment, different sounds may be created by activating controls and/or providing various inputs using a combination of sticks. For instance, to perform a drumroll, a user may select a default snare sound provided by one drumstick, and alternate between tapping both sticks in a drumroll pattern.

Drumsticks 301 can be made from a variety of natural or manmade materials, such as acrylonitrile-butadiene-styrene (ABS), and may be approximately 39.5 cm long, with a 19.5 mm diameter. According to one embodiment, drumsticks 301 may include rubber tips for tapping objects, and drumsticks 301 may each include one or more detectors that determine when the drumstick has struck an object, such as with an accelerometer, optical sensors, a microphone, or other detector type. However, according to another embodiment, drumsticks may be activated by a user without having to strike a surface (e.g., “air drumming”).

Receiver 302 may also include one or more controls and one or more inputs and outputs. For instance, receiver 302 may include an on/off control 308 that activates both the drumsticks (e.g., drumsticks 301) and receiver 302. Receiver 302 may also include a volume control 311 that controls an output volume on an audio out port 310. Also, it should be appreciated that any number of volume controls may be included that are configured to adjust sound levels for both inputs and outputs. As discussed, an audio output may be provided that is coupled to headphones, amplifier or other system capable of receiving an audio output. Receiver 302 may also include one or more audio inputs (e.g., audio input 309) for the purpose of receiving and/or mixing a received audio input with drum sounds produced by the user.

As discussed above, the receiver may be capable of storing and playing back one or more preprogrammed tracks that can be combined with audio signals produced by playing the drumsticks (e.g., drumsticks 301) and/or any audio inputs (e.g., as received at audio input 309). For instance, a control 312 may be provided that permits the user to activate a high-hat track. The receiver may include other controls for activating other preprogrammed tracks, and also may include controls for modifying the currently-selected track. For instance, a tempo control 313 may be provided to provide +/− control for a hi-hat rhythm track.

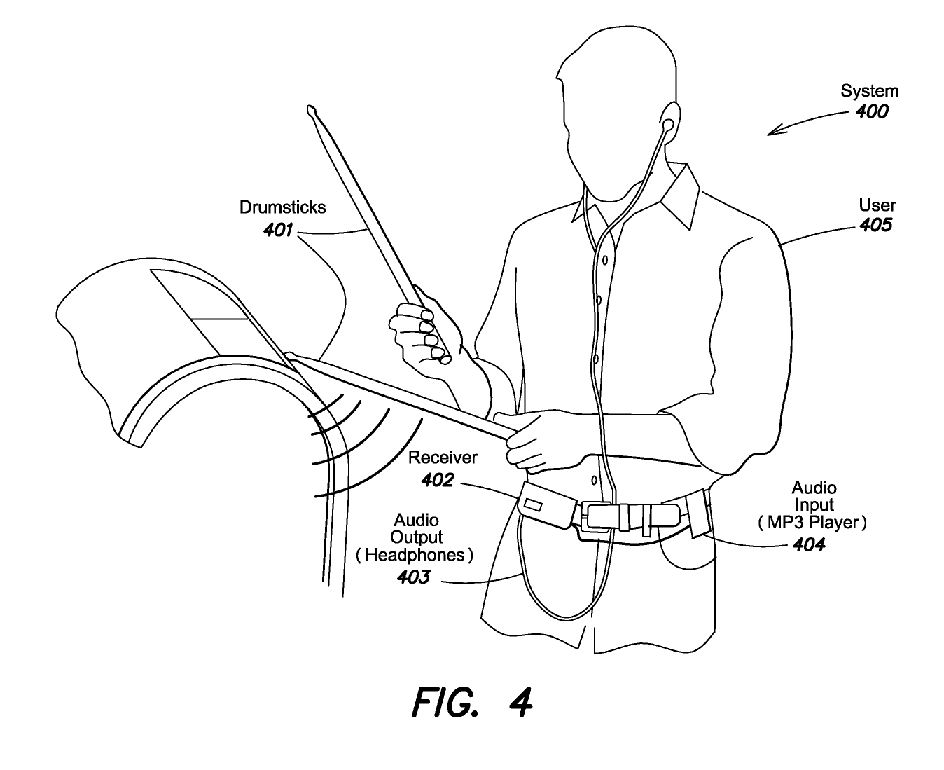

FIG. 4 shows an example use of a music system (e.g., system 300 as shown in FIG. 3) by a user 405 according to one embodiment of the present invention. In one implementation, the user (e.g., user 405) may play drumsticks 401 by striking a surface or by playing in the air to produce simulated drum sounds. Motion of the drumsticks may be communicated to a receiver 402 (e.g., wirelessly via infrared or other communication type), and/or other information regarding controls depressed by the user. For convenience, receiver 402 may be relatively small and may be easily work by the user (e.g., via a belt clip). Receiver 402 may include an audio output (e.g., output 403) such as headphones that can be worn by the user to listen to output audio signals including the produced simulated drum sounds. In one embodiment, receiver 402 may be coupled to an audio input (e.g., MP3 player 404) personal music system via an audio input port. To this end, receiver 402 may include an input jack that may be coupled to the audio input via an audio cable. Notably, system 400 provides portability not found in convention drum sets, as each of the components is portable and can be easily transported.

In one embodiment, the system may include two wireless electronic drumsticks, an IR receiving unit, a ⅛″ to ⅛″ connector cable, a ⅛″ (female) to ¼″ (male) adaptor, and earbuds. The system can be configured to automatically shut off after five minutes of non use.

The electronic drumsticks can operate wirelessly and may include:
Each stick can include a default sound and can generate a new sound when the user holds down a given button
The first stick's default sound can be a snare drum, while the top button on the first stick may trigger a cymbal, and the bottom button may trigger a high-tom
The second stick's default sound can be a kick drum, while the top button may trigger a snare, and bottom button may trigger a low-tom
A user can generate a drumroll by using the default sound of the first stick (snare) and holding down the top button on the second stick (snare)
Drumsticks can be made from a variety of natural or manmade materials, such as acrylonitrile-butadiene-styrene (ABS), and may be approximately 39.5 cm long, with a 19.5 mm diameter, and may include rubber tips, buttons, and on/off switch
Each stick may be powered by two AAA batteries and may contain a first IR transmitter near the tip, hidden by a plastic window, and a second IR transmitter at the opposite end of the stick.

The receiving unit may include:
The receiving unit can receive the triggered signal and allow a user to hear the corresponding sound through an audio output device
Sampled drum sounds
The receiving unit may include one or more built-in beat tracks, such as high-hat beat tracks, which can be activated by depressing at least one button on the receiver
One high-hat track can be composed of eighth notes, and another track can be composed of sixteenth notes
The high-hat track tempo can be adjusted by depressing the plus and minus buttons to the top and bottom of the activation button
Inputs/outputs on the receiving unit can include an audio-in jack for an MP3 player, an audio-out jack for earbuds, a stereo, amplifier, or other device
The unit can include an on/off switch and a volume adjust knob
The receiver may be equipped with a belt clip and can be powered by two AAA batteries
The unit may be made of a variety of natural or manmade materials (e.g., ABS) and may include various buttons, switches, and knobs

The product may be part of a kit providing the following accessories:
The system may include one pair of earbuds, “R” and “L” indicated on each, a two-foot ⅛″ to ⅛″ connector cable with molded ends, and an ⅛″ (female) to ¼″ (male) adaptor to enable immediate use out of the box

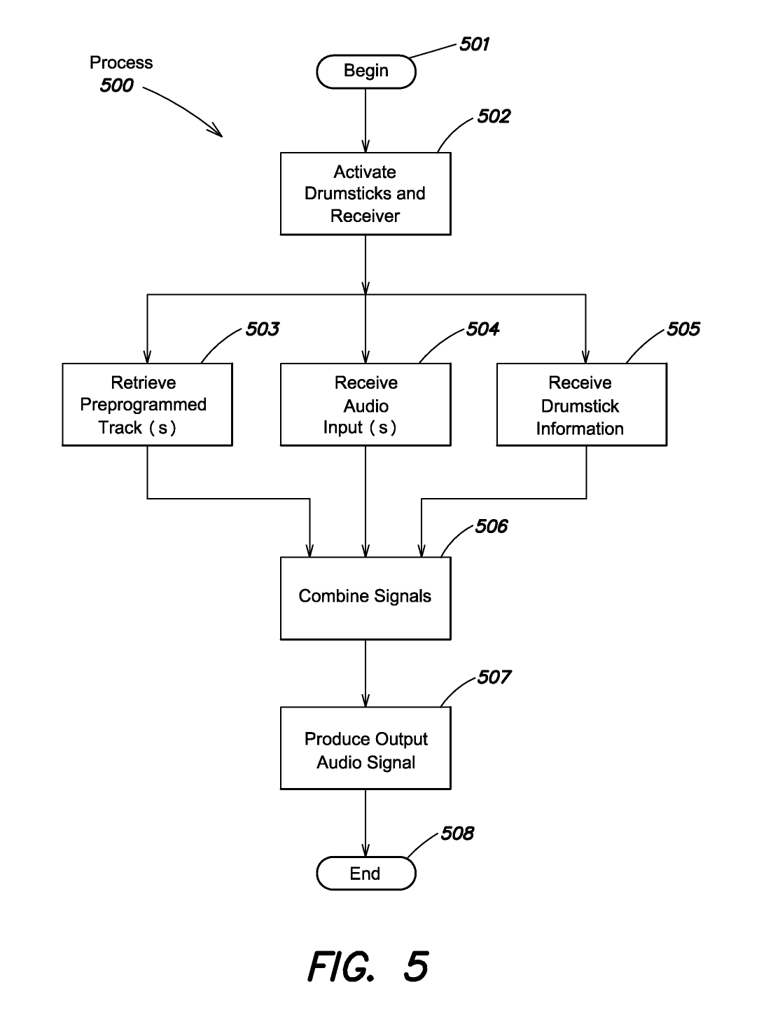

FIG. 5 shows a process 500 for processing audio signals using a music system (e.g., system 400) according to various aspects of the present invention. At block 501, process 500 begins. At block 502, the electronic drumsticks and receiver are activated as discussed above. To this end, a wireless communication link may be established, and information passes between the drumsticks and receiver, such as drumstick settings and control information.

As discussed, a receiver may be configured to receive one or more inputs (e.g., audio inputs, other information received at block 504) from a variety of sources and provide an output audio signal to headphones, amplifier or other system. According to one embodiment, a receiver may retrieve one or more preprogrammed tracks from memory (e.g., at block 503) and combine the tracks (e.g., at block 506) with audio signals produced by received drumstick information.

In one embodiment, the drumsticks themselves produce and transmit audio information. In another embodiment, information indicative of the audio information is transmitted to the receiver and received by the receiver (e.g., at block 505), and the receiver is adapted to generate the audio information (e.g., from sounds stored in a memory of a controller). Further, the system may be capable of receiving one or more additional audio inputs (e.g., an MP3 player output) that may be combined with the received audio signals at block 506.

At block 507, the system produces an output audio signal that can be heard by the user, amplified, or provided to another system. The process of receiving audio inputs and generating audio outputs can occur indefinitely, but upon selection of the user, process 500 ends at block 508.

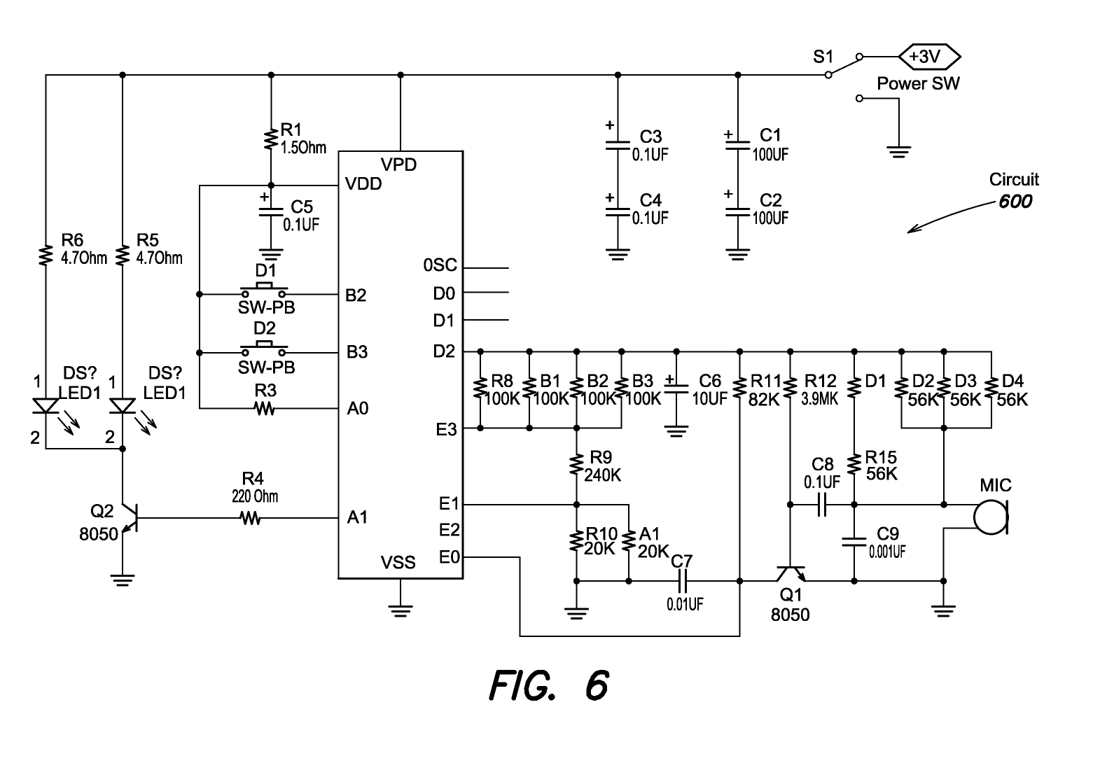

FIG. 6 shows example circuitry used for a transmitter (e.g., transmitter 101) according to one embodiment of the present invention. Such circuitry may be located with the housing of one or more of the drumsticks, and may be adapted to generate simulated drum audio signals. Transmitter circuitry 600 may utilize one or more specialized integrated circuits configured to process audio information, however, it should be appreciated that any number of circuits may be used to perform various functions according to various embodiments described herein. In one specific implementation, transmitter circuitry 600 may include the well-known TRS3B line of speech processing integrated circuits manufactured and commercially available from the Tritan Corporation, Hsin Chu, Taiwan. For instance, the TRS3BM06E-AP338 integrated circuit may be used. Such an integrated circuit generally includes a controller, a memory to store programs and program data, and, according to one embodiment, preprogrammed instrument sounds (e.g., sounds of various drum types) that may be simulated. However, it is appreciated that other types of integrated circuits may be used. Notably, the transmitter circuitry may include one or more infra-red diodes used to wirelessly communicate information to the receiver. Such diodes may be positioned at the tip and opposite end of each drumstick. However, it should be appreciated that other transmission methods may be used.

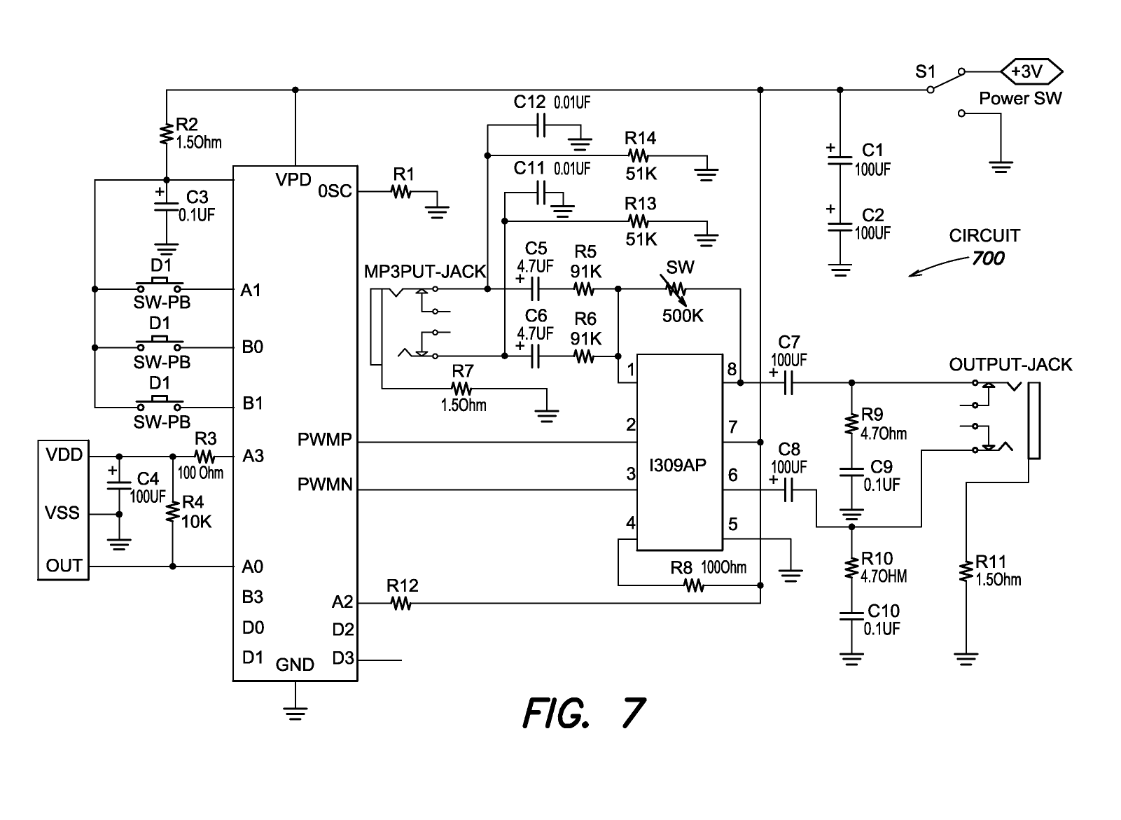

FIG. 7 shows example circuitry used for a receiver (e.g., receiver 102) according to one embodiment of the present invention. Such circuitry may be located with the housing of a dedicated receiver component. Alternatively, such circuitry may be located within one or more of the drumsticks. The receiver circuitry 700 may be adapted to receive a number of input audio signals and combine them with the generated simulated drum audio signals provided by a transmitter (e.g., transmitter circuitry 600). Receiver circuitry 700 may utilize one or more specialized integrated circuits configured to process audio information, however, it should be appreciated that any number of circuits may be used to perform various functions according to various embodiments described herein. In one specific implementation, receiver circuitry 700 may include the well-known TRS3B line of speech processing integrated circuits manufactured and commercially available from the Tritan Corporation, Hsin Chu, Taiwan. For instance, the TRS3BH128D-AP350 integrated circuit may be used that produces a two channel PWM audio output. However, it is appreciated that other types of integrated circuits may be used. The receiver may also include one or more infra-red diodes that receive the wireless IR signals generated by the drumsticks. However, it should be appreciated that other transmission methods may be used.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “containing”, “characterized by” and the like are to be understood to be open-ended, i.e., to mean including but not limited to. Only the transitional phrases “consisting of” and “consisting essentially of”, respectively, shall be closed or semi-closed transitional phrases.

What is claimed is:

1. A electronic music system comprising:
at least one drumstick including:
a detector that detects play of the at least one drumstick;
a transmitter that is capable of transmitting information indicating the play of the at least one drumstick; and
a receiver that receives information indicating the play of the at least one drumstick, the receiver having an audio input capable of accepting an input audio signal, and wherein the receiver is configured to combine the input audio signal with an audio signal corresponding to the information indicating the play of the at least one drumstick, and wherein the receiver provides, as an output, an output audio signal representing the combined input audio signal and audio signal indicating the play of the at least one drumstick.

2. The system according to claim 1, wherein the transmitter is configured to transmit the information to the receiver using a wireless communication protocol.

3. The system according to claim 1, wherein the receiver includes at least one preprogrammed track stored in a memory device of the receiver.

4. The system according to claim 3, wherein the receiver is adapted to combine the preprogrammed track with the combined input audio signal and audio signal indicating the play of the at least one drumstick.

5. The system according to claim 3, wherein the receiver includes a control that permits a user to select the at least one preprogrammed track.

6. The system according to claim 1, wherein the at least one drumstick and the receiver are part of a portable system.

7. The system according to claim 1, wherein the receiver is housed within another drumstick.

8. The system according to claim 5, wherein the receiver includes a control adapted to adjust a tempo of the at least one preprogrammed track.

9. The system according to claim 1, wherein the receiver includes a control to adjust an output level of the output audio signal.

10. The system according to claim 1, wherein the audio input is capable of being coupled to an output of a personal music player.

11. The system according to claim 2, wherein the at least one drumstick comprises an infrared transmitter and is adapted to transmit the information indicating the play of the at least one drumstick to the receiver via the infrared transmitter.

12. A method for processing audio signals, the method comprising acts of:
electronically detecting play of at least one drumstick;
transmitting information indicating the play of the at least one drumstick;
receiving, by a receiver, information indicating the play of the at least one drumstick, the receiver having an audio input;
receiving, by the receiver, an input audio signal;
combining, by the receiver, the input audio signal with an audio signal corresponding to the information indicating the play of the at least one drumstick; and
providing, as an output, an output audio signal representing the combined input audio signal and audio signal indicating the play of the at least one drumstick.

13. The method according to claim 12, further comprising an act of transmitting the information to the receiver using a wireless communication protocol.

14. The method according to claim 12, further comprising an act of storing, within a memory device of the receiver, at least one preprogrammed track.

15. The method according to claim 14, further comprising an act of combining the preprogrammed track with the combined input audio signal and audio signal indicating the play of the at least one drumstick.

16. The method according to claim 14, further comprising an act of providing a control that permits a user to select the at least one preprogrammed track.

17. The method according to claim 12, wherein the at least one drumstick and the receiver are part of a portable system.

18. The method according to claim 12, wherein the receiver is housed within another drumstick.

19. The method according to claim 14, further comprising an act of providing a control adapted to adjust a tempo of the at least one preprogrammed track.

20. The method according to claim 12, further comprising an act of providing a control to adjust an output level of the output audio signal.

21. The method according to claim 12, wherein the audio input is capable of being coupled to an output of a personal music player.

22. The method according to claim 13, further comprising an act of transmitting, by an infrared transmitter of the at least one drumstick, the information indicating the play of the at least one drumstick to the receiver.
